(19) United States
(12) Patent Application Publication
(10) Pub. No.: US 2017/0067276 A1
(43) Pub. Date: Mar. 9, 2017

(54) Hanging Door Apparatus and System

(71) Applicant: Rudy APODACA, Cedar Park, TX (US)

(72) Inventor: Rudy APODACA, Cedar Park, TX (US)

(21) Appl. No.: 15/257,898

(22) Filed: Sep. 6, 2016

Related U.S. Application Data
(60) Provisional application No. 62/214,706, filed on Sep. 4, 2015.

(51) Int. Cl. E05D 15/06

(52) U.S. Cl. CPC E05D 15/0639; E05Y 2900/132

(57) ABSTRACT

Disclosed is a hanging door system comprising a hanger track, one or more rolling hangers mountable on the hanger track, and a hanging door suspended from the hanger track by the rolling hangers. The hanger track supported by one or more mounting brackets comprising a mounting surface and a clamp defining a gap adapted for receiving the hanging track. Alternative embodiments are also disclosed wherein the track is L-shaped, the rolling hanger comprises a stop arm, and the rolling hanger is vertically adjustable.

Applicant claims the benefit of U.S. Provisional Application No. 62/214,706, filed on Sep. 4, 2015, which application is incorporated by reference in its entirety.

### FIELD OF THE INVENTION

The field of the invention is door hardware.

### BACKGROUND OF THE INVENTION

With the recent trend toward rustic elegance and the necessity for designs that bring both an esthetic value and a functional solution. Sliding-style doors, commonly referred to as “barn doors” have become a major component for DIY and contractor installation. These doors minimize space constraints caused by swinging doors in small places such as bathrooms and laundry rooms, but also bring a decorative flare to any room.

Given the demand for these sliding doors, a combination of both esthetic value and safety requirements are a must. Installation of these doors then becomes a challenge to combine the two.

Traditional sliding doors have a mounting system that while offering an attractive look, often lacks in safety and ease of installation. Conventional mounting hardware consists of basic components, a track, mounting spacers, lag bolts, door hangers/rollers, floor door guides, and door stops. Most off-the-shelf hardware comes with a pre-drilled track at 16 inch centers for placement on wall studs. This is fine when studs are where they are supposed to be, but sometimes the pre-drilled mounting holes in the metal rail may not align horizontally with the location of support studs or the pre-drilled pilot holes in the support stud. While it may be possible to drill holes in a metal rail to line up with pre-drilled pilot holes in the wall studs, drilling holes in metal requires additional tools, accuracy, and strength, significantly extends the time to install a door, and leaves unsightly unused holes in the track. Additionally, the lag bolt system creates a safety issue, as the off-the-shelf hardware comes with three-inch lag bolts that must penetrate the track, a 1-inch thick spacer, and sheetrock ¾ inch thick. This does not leave much bolt length to securely and safely hold the weight of the track and suspended door. Plus, the combined weight of the rail and the door imposes a vertical load on the head end of the bolt which can cause the spacer and lag bolt to bend and crush into the sheet rock or other wall material below the bolt.

In addition, the doors in some hanging door systems may come off the tracks, for example under heavy winds or powerful lateral door forces.

Finally, sometimes it may be desirable to adjust the distance between the top edge of the hanging door and the rail from which it is suspended. It may be desirable, for example, to raise the bottom edge of the door above the ground or floor. Or, when two or more doors are hung together, sometimes the top edges of the doors may not be aligned horizontally in a pleasing manner.

### SUMMARY OF THE INVENTION

Disclosed is a hanging door system comprising a hanger track, one or more rolling hangers mountable on the hanger track, and a hanging door suspended from the hanger track by the rolling hangers. The hanger track supported by one or more mounting brackets comprising a mounting surface and a clamp defining a gap adapted for receiving the hanging track. Alternative embodiments are also disclosed wherein the track is L-shaped, the rolling hanger comprises a stop arm, and the rolling hanger is vertically adjustable.

### BRIEF DESCRIPTION OF THE DRAWINGS

The detailed description may refer to the following drawings, wherein like numerals refer to like elements, and wherein:

FIG. 1 depicts an embodiment of a hanging door mounting bracket and hanger track.

FIG. 2 depicts an exemplary hanging door system.

FIG. 3 depicts an embodiment of a hanging door mounting bracket.

FIG. 4 depicts an embodiment of a hanging door mounting bracket mounted on a support surface and hanger track.

FIG. 5 depicts an alternative view of an embodiment of a hanging door mounting bracket.

FIG. 6 depicts an alternative view of an embodiment of a hanging door mounting bracket.

FIG. 7 depicts an alternative view of an embodiment of a hanging door mounting bracket.

FIG. 8 depicts an alternative embodiment of a hanging door mounting bracket.

FIG. 9 depicts an embodiment of a hanger.

FIGS. 10A, 10B, and 10C depict an alternative embodiment of a hanging door mounting bracket with an alternative embodiment of a rail.

FIG. 11 depicts a hanging door system.

FIGS. 12A and 12B depict an embodiment of an adjustable hanger.

### DETAILED DESCRIPTION OF THE PREFERRED EMBODIMENTS

Embodiments of the mounting brackets described herein are constructed of cross-sections of rectangular steel tubing and right angle steel. Embodiments of the rail described herein are constructed of flat bar steel and right angle steel with varying dimensions and 3/16 inch thickness. The pieces may be cut using conventional steel cutting methods. Embodiments of the hangers and hardware described herein may also include purely ornamental design elements that do not contribute to the hanging and other functions of the hardware.

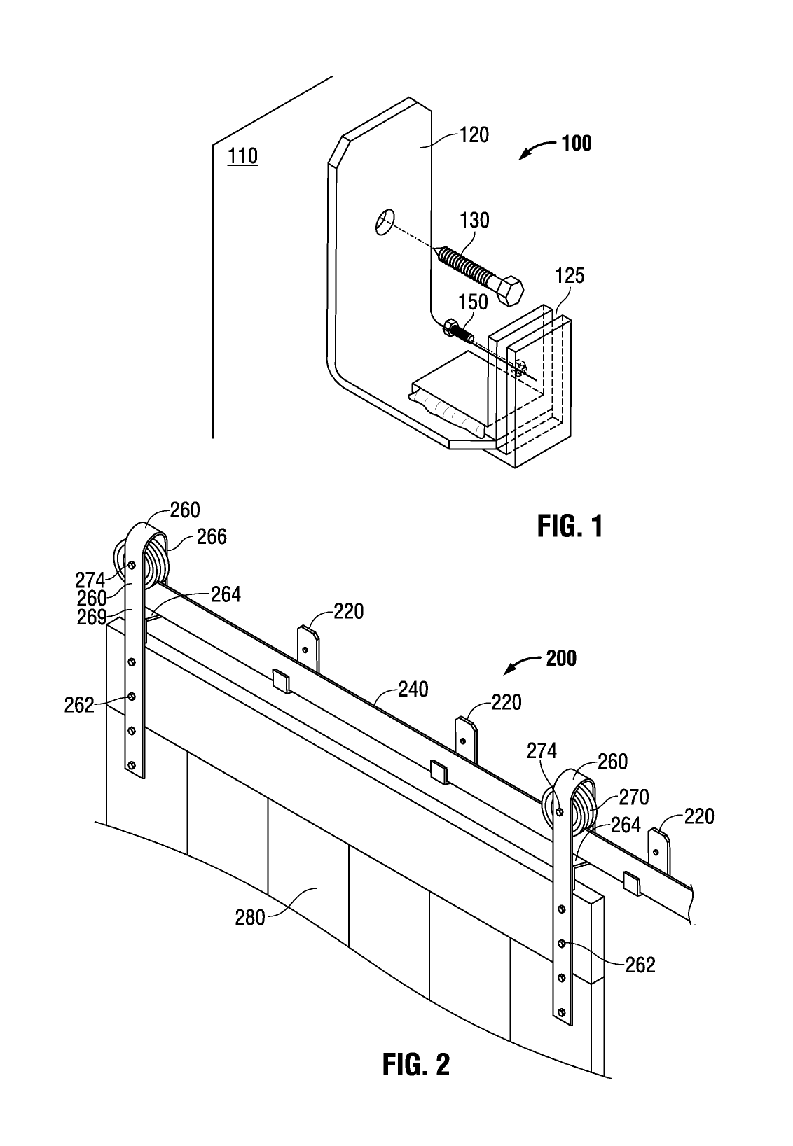

FIG. 1 depicts part of hanging door system 100 comprising mounting bracket 120 and rail 140. Mounting bracket 120 is secured to wall 110 by fastener 130, which in an embodiment is a lag screw. Rail 140, also called a track or hanging track, is secured to mounting bracket 120 by rail bolt 150, which in an embodiment is a bolt 150 that extends through an opening (not shown) in mounting bracket 120 to apply pressure on rail 140.

FIG. 2 depicts an exemplary hanging door system 200 comprising track 240, two or more mounting brackets 220, hangers 260, and barn door 280, which is secured to hangers 260 and suspended thereby from rail 240. Mounting brackets 220 are secured to wall 210 with fasteners (not shown). Track 240 is mounted on and supported by mounting brackets 220. Hangers 260 roll on rail 240 via wheels 270, which are secured to hanger 260 by mounting bolts 274. Hanger 260 comprises stop arm 264. In an embodiment, hanger 260 is a j-shaped steel bar with the short curved bent over wheel 270 so that mounting bolt 274 extends from the hanger outer part 269 of hanger 260 through wheel 270 to connect to the hanger inner part 266.

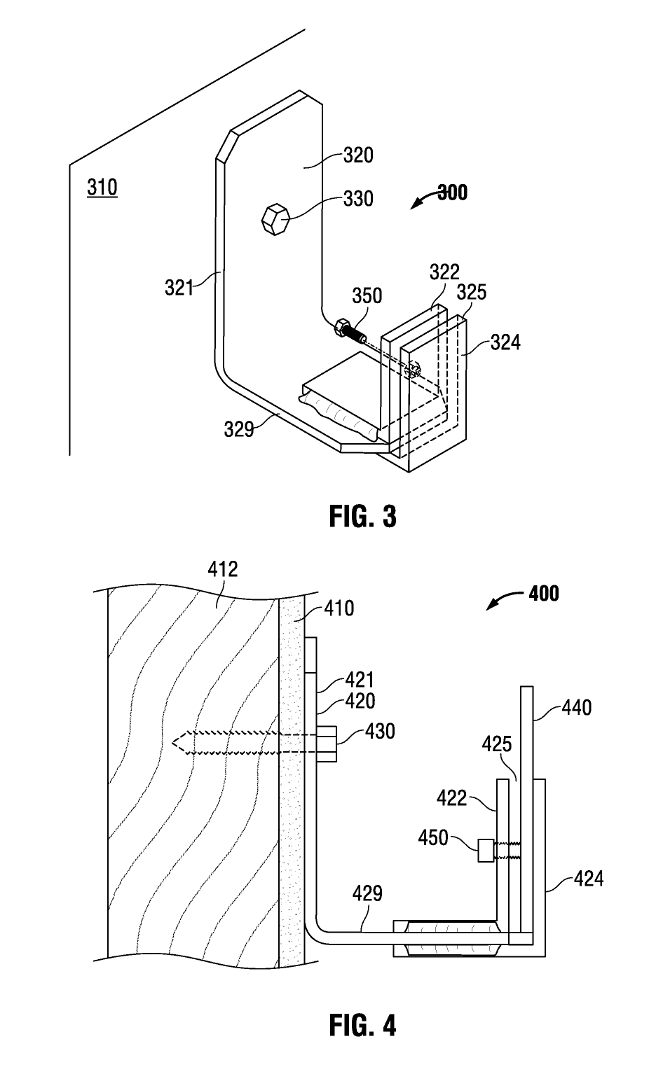

FIG. 3 depicts an embodiment of a hanging door mounting bracket 300, including mounting bracket 320 secured to wall 310. Mounting bracket 320 includes wall plate 321, arm 329, outer jaw 324, and inner jaw 322. Lag screw 330 protrudes through an opening (not shown) in wall plate 321 to fasten mounting bracket 320 to wall 310. Outer jaw 324 and inner jaw 322 preferably are substantially parallel to each other and define a slot 325 between them that is adapted and configured to receive and hold a rail (not shown). In an embodiment, outer jaw 324 and inner jaw 322 are substantially planar surfaces connected via arm 329 to wall plate 321 and substantially parallel to wall plate 321 and wall 310.

FIG. 4 depicts a cross-section view of hanging door mounting bracket 400. Mounting bracket 420 is fastened to wall 410 with fastener 430. In an embodiment mounting bracket 420 includes wall plate 420, which contacts wall 410, arm 429, outer jaw 424, and inner jaw 422. Fastener 430 in an embodiment is a lag screw that protrudes through an opening (not shown) in wall plate 421, through wall 410, and into stud 412. Rail 440 is inserted in slot 425 between inner jaw 422 and outer jaw 424. Rail bolt 450 extends through an opening (not shown) in inner jaw 422 and can be tightened so as to contact an inner surface of rail 440 and thereby secure rail 440 to mounting bracket 420. In embodiment rail bolt 450 extends through a threaded opening in inner jaw 422. In an embodiment the bottom edge of rail 440 rests on outer jaw 424.

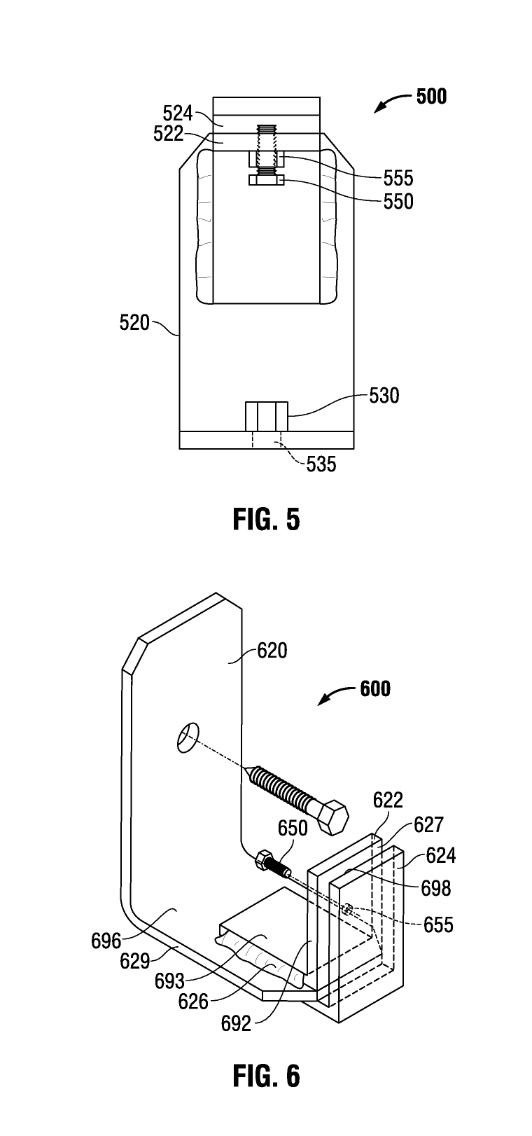

FIG. 5 depicts an alternative perspective of an embodiment of a hanging door mounting bracket 500. Mounting bracket 520 includes wall plate 521, arm 529, inner jaw 522 and outer jaw 524. Threaded nut 555 is secured to inner surface 554 of inner jaw 522, preferably by a welded joint, so as to allow rail bolt 550 to extend through threaded nut 557 and a threaded or unthreaded opening (not shown) in inner jaw 522 and to be tightened against a rail inserted in slot 525. In an alternative embodiment, there is no threaded nut 557 and rail bolt 550 extends through a threaded opening in inner jaw 522. Wall plate 521 includes opening 535 through which a lag screw is inserted to secure mounting bracket 520 to a wall.

FIG. 6 depicts an alternative view of an embodiment of a hanging door mounting bracket 600. Mounting bracket 620 comprises arm 629, inner jaw 622, and outer jaw 624. Outer surface 627 of inner jaw 622 and inner surface 698 (not visible) of outer jaw 624 define slot 625. In an embodiment depicted in FIG. 6: inner jaw 622 is L-shaped with vertical member 692 and support member 693; rail bolt 650 extends through hole 655 in vertical member 692 of inner jaw 622 to secure a rail (not shown) to mounting bracket 620; and support member 693 of inner jaw 622 is secured to top surface 696 of arm 629 by, preferably, welded joint 626.

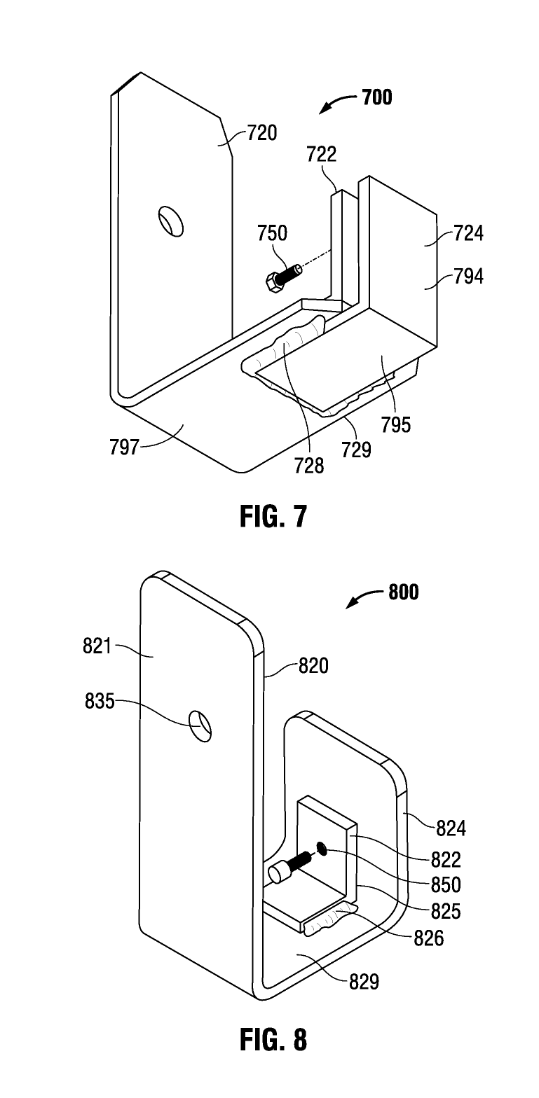

FIG. 7 depicts an alternative view of an embodiment of a hanging door mounting bracket 700. Mounting bracket 720 comprises arm 729, inner jaw 722, and outer jaw 724. In an embodiment depicted in FIG. 7: outer jaw 724 is L-shaped with vertical member 794 and support member 795; and support member 795 of outer jaw 724 is secured to bottom surface 797 of arm 629 by, preferably, welded joint 728.

FIG. 8 depicts an alternative embodiment of a mounting bracket 820 comprising a wall plate 821, arm 829, outer jaw 824, and inner jaw 822. Inner jaw is an embodiment is a rectangular piece of steel secured to arm 829 by, preferably, a welding joint 826 along the bottom long edge. Outer jaw 824 and inner jaw 822 define a slot 825 adapted and configured to hold a rail (not shown), which can be secured in place by rail bolt 850 extending through an opening (not shown) in inner jaw 822, said opening being preferably threaded. Wall plate 821 includes opening 835 adapted and configured to permit a fastener to secure mounting bracket 820 to a wall.

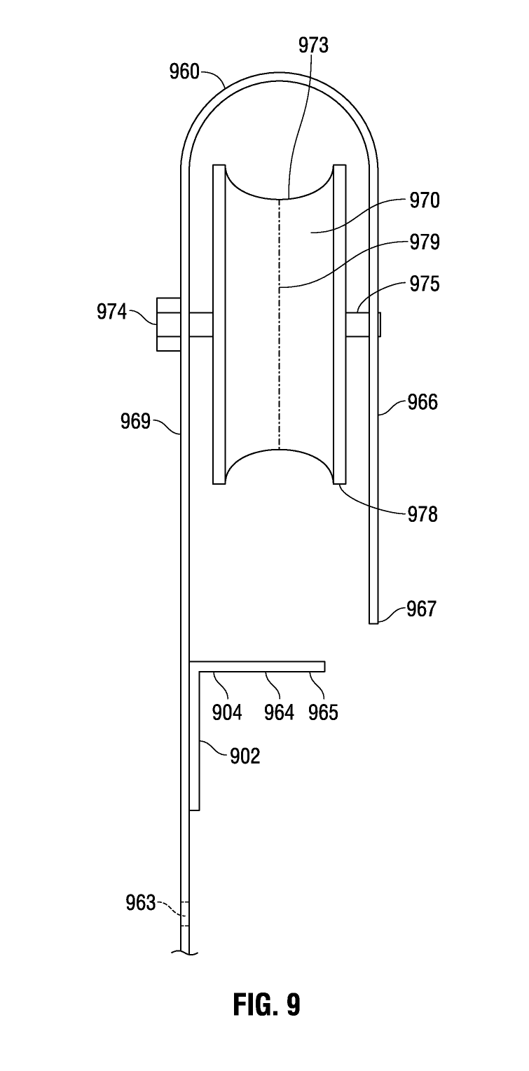

FIG. 9 depicts an embodiment of a hanger 960 adapted for use in a hanging door system. Hanger 960 in an embodiment is a piece of flat bar steel bent into a “J” shape by conventional metal bending methods so that the curved part of the j-shaped bar includes hanger outer part 969 and hanger inner part 966. Hanger inner part 969 and hanger outer part 966 are preferably substantially parallel to each other. Wheel 970 is mounted between hanger inner part 969 and hanger outer part 966 using mounting bolt 974 and other conventional wheel mounting hardware 975. In an embodiment wheel 970 includes groove 973 to receive and roll along a steel rail. Hanger 960 includes one or more openings 963 to receive a fastener to attach hanger 960 to a hanging door. Hanger 960 in an embodiment includes stop arm 964. In an embodiment, stop arm 964 comprises an L-shaped piece of steel comprising a support leg 902 and a projecting arm 904 having end 965. In an embodiment, support leg 902 preferably is affixed to hanger 960 by a welding joint (not shown) or conventional fastener (not shown). Projecting arm 904 extends horizontally outward from hanger 960. The length of projecting arm 904 in an embodiment extends horizontally beyond the center line 979 of wheel 970 but not beyond the inner edge 978 of wheel 970.

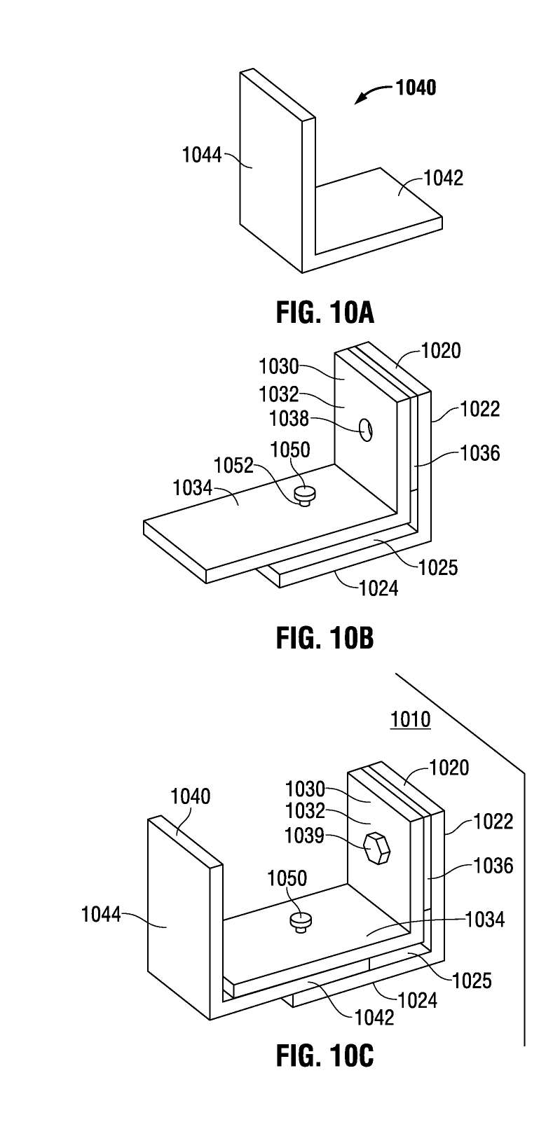

FIGS. 10A, 10B, and 10C depict an alternative embodiment of a hanging door mounting bracket with an alternative embodiment of a rail. FIG. 10A depicts an excerpt of an exemplary L-shaped rail 1040 having rail part 1044 and mounting part 1042.

FIG. 10B depicts an alternative embodiment of a mounting bracket 1020. Mounting bracket 1020 comprises wall plate 1022, support arm 1024 and in an embodiment is an L-shaped piece of steel. Mounting bracket 1020 also includes clamp 1030, comprising clamp support 1032 and claim arm 1034. In an embodiment clamp 1030 is an L-shaped piece of steel and is affixed to mounting bracket 1020 by a weld joint 1036 between clamp support 1032 and wall plate 1022. Mounting bracket 1020 may be secured to a wall or other support surface by a fastener extending through opening 1038 in clamp support 1032 and corresponding opening (not shown) in wall plate 1022. Clamp arm 1034 and support arm 1024 define slot 1025 between them adapted and configured to receive and hold securely a rail mounting part. Clamp arm 1034 comprises opening 1052 through which extends rail bolt 1050 to secure a rail mounting part inserted in slot 1025.

FIG. 10C shows mounting bolt 1020 mounted on wall 1010 via fastener 1039 extending through jaw support 1032 and wall plate 1022 and rail excerpt 1040 mounted in mounting bracket 1020 and secured to mounting bracket 1020 by rail bolt 1050.

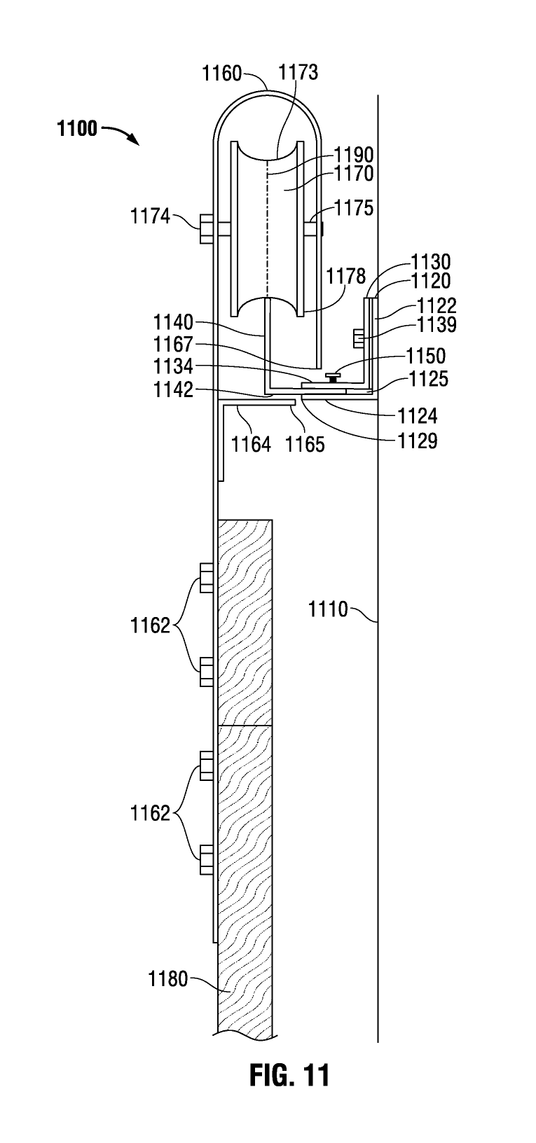

FIG. 11 depicts a hanging door system 1100 comprising hanger 1160, rail 1140, and mounting bracket 1120. Mounting bracket 1120 is mounted on wall 1110 with fastener 1039 extending through clamp support 1132 and wall plate 1122. Rail 1140 is mounted securely in mounting bracket 1120 with mounting part 1142 of rail 1140 inserted into slot 1125 between support arm 1124 and clamp arm 1134 and secured with rail bolt 1150 extending through clamp arm 1134. Hanger 1160 includes wheel 1170 which is mounted on and rail part 1140. Wheel 1170 includes groove 1173. In an embodiment the low point of groove 1173 aligns with the center 1190 of wheel 1170. Hanger 1160 includes stop arm 1164 which extends horizontally so that stop arm tip end 1165 extends beyond the center of wheel 1170 and groove 1173 but not beyond the inner edge 1178 of wheel 1170. Stop part 1164 is disposed under mounting part 1142 of rail 1140 so that mounting part 1142 does not impede travel of hanger 1160 along rail 1140. Tip end 1139 of support arm 1124 preferably does not extend horizontally beyond the inner edge 1178 of wheel 1170. Hanger 1160 is fastened to hanging door 1180 with fasteners 1162.

In an embodiment, stop arm 1164 is a safety feature that prevents the hanging door 1180 from falling off the track. If the vertical distance between hanger end 1167 and stop arm tip end 1165 is less than the depth of groove 1173, and preferably at least ⅛″ less than the depth of groove 1173, it is practically impossible for hanger 1160 to slip off of track 1140. Also, the wall 1110 preferably blocks hanger 1160 from being turned inward so as to fall off rail 1140.

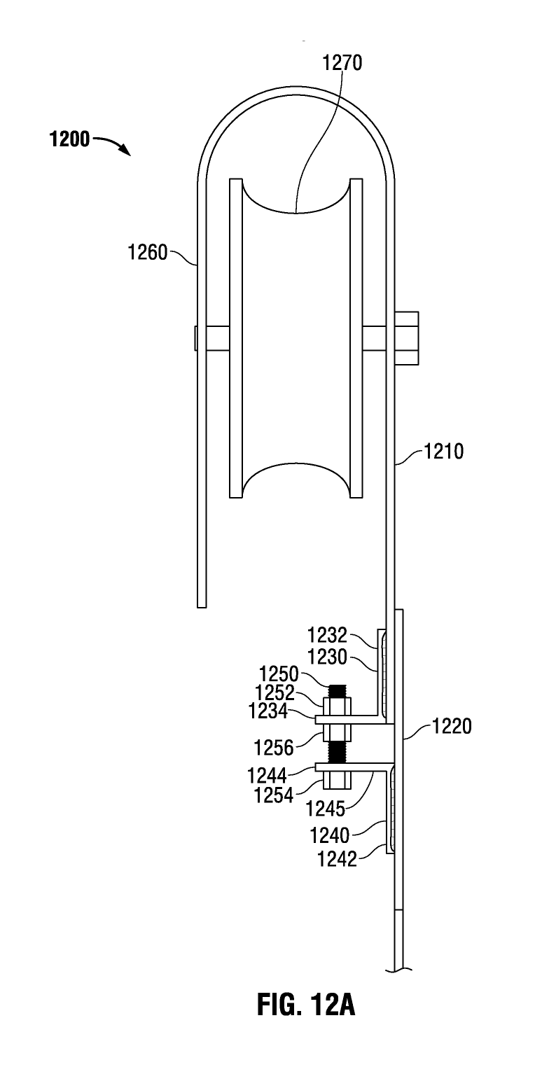

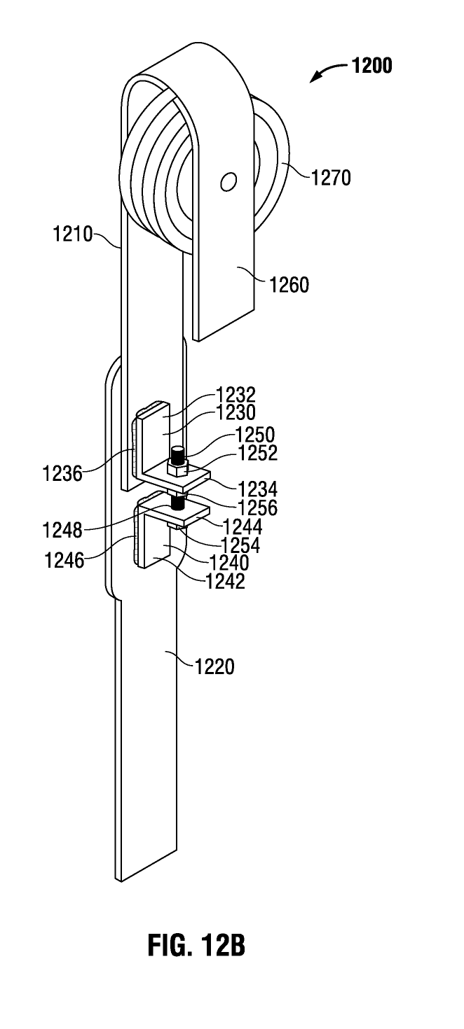

FIGS. 12A and 12B depict an embodiment of an adjustable hanger 1260. Adjustable hanger 1260 comprises an upper hanger 1210 and lower hanger 1220, each constructed, in an embodiment, of flat bar steel. Upper hanger 1210 comprises wheel 1270 for rolling on the door hanging track, and lower hanger 1220 can be fastened to a hanging door via fasteners inserted through openings (not shown) in lower hanger 1220. Affixed to upper hanger 1210 is upper bolt mount 1230 comprising upper bolt arm 1234 and support 1232. Upper hanger 1210 in an embodiment includes a stop arm (not shown) and upper bolt mount 1230 is preferably affixed to upper hanger 1210 below the stop arm. In an embodiment, support 1232 is affixed to upper hanger 1210 by welded joint 1236. Affixed to lower hanger 1220 is lower bolt mount 1240 comprising lower bolt arm 1244 and support 1242. In an embodiment, support 1242 is affixed to lower hanger 1220 by welded joint 1246. Lower bolt arm 1244 includes an opening 1248 which can be aligned with a corresponding opening (not shown) in upper bolt arm 1234. Bolt 1250 extends vertically upward through opening 1248 and through threaded nut 1256, below upper bolt arm 1234, through an opening (not shown) in upper bolt arm 1234, and through threaded nut 1252, above upper bolt arm 1234. In an embodiment, bolt head 1254 of bolt 1250 may be affixed to lower surface 1245 of lower bolt arm 1244 by a welded joint (not shown) or one of nuts 1252 or 1256 may be affixed to upper bolt arm 1234 by a welded joint (not shown). In an embodiment, upper and lower bolt mounts 1230 and 1240, bolt 1250, and nuts 1256 and 1252 provide the sole means of joining together upper hanger 1210 and lower hanger 1220, which otherwise are not attached to each other. The vertical distance from wheel 1270 to lower hanger 1220 can be vertically adjusted by vertically adjusting the location of threaded nut 1252 on bolt 1250, and thus the height of the door suspended from lower hanger 1220 can be adjusted vertically in relation to the rail from which it is suspended.

In practice, sometimes it is desirable to adjust the height of one or more sides of a hanging door. For example, when hanging two or more doors, sometimes the top or side edges of the doors may not be aligned as desired. This problem can be solved by using one or more adjustable hangers 1260 to hang the doors and vertically adjusting the height of one or more sides of the door as needed to achieve the desired alignment or distance between the top of the door and the rail from which it is suspended.

The embodiments of a door hanging apparatus and system described herein overcome multiple problems encountered with exposed rail hanging door systems. The mounting brackets can be quickly mounted to wall studs at any spacing and securely hold the hanging door tracks without having to drill holes in the metal. Because the lag bolts that secure the mounting brackets to the wall are not extended, there is no risk of the bolts and spacers bending under the weight of the rail and door and damaging the wall. The unique integrated relationship between the wall mount and the door hanger makes the door hanger more safe. The hanger can travel freely along the track, but has critical spatial designs that make unintentional or accidental removal of the hanger from the track impossible. In short, the embodiments of a hanging door mounting system described herein simplify installation, incorporate safety features that minimize risk/possible injury, and provide an esthetic look that complements any home or commercial application.

Although embodiments of the present invention have been described in detail, it will be apparent to those skilled in the art that many embodiments taking a variety of specific forms and reflecting changes, substitutions and alterations can be made without departing from the spirit and scope of the inventions disclosed herein. The described embodiments illustrate the scope of the claims but do not restrict the scope of the claims.

What is claimed is:

1. A hanging door system, comprising:
a hanger track;
a hanging door comprising one or more rolling hangers mountable on the hanger track, wherein the door can be suspended from the hanger track by the one or more rolling hangers; and
two or more hanger track mounting brackets adapted for supporting the hanger track,
wherein each of the two or more hanger track mounting brackets comprises:
a bracket comprising a first mounting surface mountable on a support surface and a clamp, the clamp comprising:
a first clamp jaw comprising an opening;
a second clamp jaw;
a gap between the first clamp jaw and second clamp jaw, the gap defining a track slot adapted for receiving the hanger track; and
a securing bolt adapted to be inserted through the opening to secure the hanger track in the track slot between the first clamp jaw and the second clamp jaw.

2. The hanging door system of claim 1, wherein the rolling hanger further comprises a stop arm.

3. The hanging door system of claim 1, wherein the track is L-shaped.

4. The hanging door system of claim 1, wherein the rolling hanger is vertically adjustable.

5. For use in a hanging door system comprising a door suspended from a hanger track by one or more rolling door hangers, a hanging door mounting bracket comprising:
a bracket comprising a first mounting surface mountable on a support surface and a clamp, the clamp comprising:
a first clamp jaw comprising an opening;
a second clamp jaw;
a gap between the first clamp jaw and second clamp jaw, the gap defining a track slot adapted for receiving a hanger track; and
a securing bolt adapted to be inserted through the opening to secure the hanger track in the track slot between the first clamp jaw and the second clamp jaw.

6. The hanging door system of claim 5, wherein the rolling hanger further comprises a stop arm.

7. The hanging door system of claim 5, wherein the track is L-shaped.

8. The hanging door system of claim 5, wherein the rolling hanger is vertically adjustable.
